(19) United States
(12) Patent Application Publication
(10) Pub. No.: US 2010/0271208 A1
(43) Pub. Date: Oct. 28, 2010

(54) Wireless Network-Based Action-Oriented System For Remote Wireless Alerting And Action

(76) Inventors: Jay Steinmetz, Baltimore, MD (US); Lawrence Cuthie, Parkton, MD (US)

Correspondence Address: TOWNSEND & BANTA;c/o PORTFOLIO IP, PO BOX 52050, MINNEAPOLIS, MN, 55402, US

(21) Appl. No.: 12/750,839

(22) Filed: Mar. 31, 2010

Related U.S. Application Data
(63) Continuation-in-part of application No. 11/897,357, filed on Aug. 30, 2007, now Pat. No. 7,719,422.

(51) Int. Cl. G08B 13/14

(52) U.S. Cl. 340/572.1

(57) ABSTRACT

The present invention provides a wireless network-based action-oriented system comprising one or more mobile devices, which may be worn on or carried by a user, and which may be activated by the user to wirelessly communicate, via a wireless network, a signal to a base station to execute an action initiation command, such as a stoppage of nearby associated machinery or vehicles, activation of heating, cooling and lighting systems, etc. Alternatively, sensors and/or detectors disposed on or in communication with the mobile device may be activated by a user to transmit sensed/detected data to the base station, or to autonomously transmit sensed/detected data, which the base station may then act upon. The system further includes a computer software program product, which links the mobile device, access points, base stations and associated units (such as machinery, vehicles, electronics, etc.), and which allows the base station to communicate with associated units to order an execution of an action thereby. The system may further have a barcode scanner or identification code reader in communication with the base station, and each mobile device may further contain a barcode or unique identification number, such that mobile device data may be entered into the base station server with ease and active controls set on the mobile device. Thus, the mobile device, in conjunction with the system and corresponding computer program product, allows a user to have the ability to immediately initiate a remote action, such as the halting of operation of industrial equipment, electronics, heating and cooling systems, lighting, vehicles, etc. in communication with the system of the present invention operating over a wireless network, and allows system managers to easily set controls associated with each mobile device.

### REFERENCE TO RELATED APPLICATION

This application is a CIP (continuation-in-part) application of application Ser. No. 11/897,357, filed Aug. 30, 2007, now allowed, the contents of which are incorporated herein by reference.

### FIELD OF THE INVENTION

The present invention provides a wireless communications network and/or internet protocol-based action-oriented system comprising a mobile device having an active RFID tag and/or a subscriber identity module (SIM) card therein/thereon and/or an alternative means of identification, which may be passively activated by one or more sensors/detectors provided on the mobile device, or actively activated by the user of the mobile device, to wirelessly communicate a command directly to a base station on a wireless network, to the base station via an access point and/or via an ad hoc network of mobile devices, to control associated machinery, vehicles, electronics, etc. The base stations and/or mobile devices are operable to subsequently initiate an authorized action, including communicating warnings to system users and commands to machinery, vehicles, electronics, etc. in communication with the base stations and/or mobile devices.

### BACKGROUND OF THE INVENTION

Single action user-initiated action devices have been previously used for applications such as work stoppage devices. Such work stoppage devices have been provided, for example, to allow a user to depress a button or activate a switch to permanently or temporarily cease operation of an industrial machine. These work stoppage devices are traditionally fixed mounted to the industrial machines they are designed to control, but in some instances are movable.

Usage of these work stoppage devices, however, requires the individual witnessing, or involved in, an industrial machine-related accident to attempt to terminate the activity of the industrial machine involved by running to or reaching for the fixed mounted or movable work stoppage device. This required physical movement of the user or witness effectively eliminates a remote witness from activating the device in a timely manner, and potentially delays the deactivation by the user of the industrial machine involved. Further, the necessity to physically activate a remotely located device may also potentially lead to further injury of the user if, for example, the user is trapped in the machinery.

In another conventional application of a user-initiated action device, a wireless warning device has been provided, mainly for senior citizens or disabled persons, which allows the user to activate same by depressing a button thereon. When activated, the device calls an emergency medical team to assist the user. Further, a device has been built by Symbol Technologies™ as a stationary button, acting as a “kanban” or flag, to send a signal to a central location to notify same that parts are needed in a specific area. However, these conventional devices fail to address the problem of geographical monitoring of a user, correlation of the geographical location of a user to corresponding machinery and/or vehicles authorized to be controlled by a user, and wireless initiation of an authorized action/command by one or more users, or automatic initiation of authorized actions/commands upon receipt of sensed/detected data.

Further, conventional user-initiated action devices suffer from frequent lack of connectivity. More specifically, conventional mobile user-initiated action devices frequently are carried/worn in locations having a lack or difficulty in connectivity with wireless and/or telecommunications systems. If no connectivity is available for the device, the device is rendered useless, which can be tragic in emergency situations when the user is dependent thereon. Accordingly, there is a need for increasing the effective range of communication of mobile user-initiated action devices.

In view of the deficiencies of the conventional devices and systems for emergency notification and command communications, as discussed above, it is an object of the present invention to provide a wireless network and/or internet protocol-based action-oriented mobile device, and system containing one or more of same, to allow a user to remotely notify a base station/computer processing means of a current or impending emergency situation or automatically transmit detected/sensed data. The central location/computer processing means will, subsequently, wirelessly communicate with associated machines, vehicles, electronics, etc. to request initiation of preassigned actions based on the user command and/or detected/sensed data.

It is another object of the present invention to provide a wireless network and/or internet protocol-based action-oriented mobile device, and system containing same, as called for above, wherein the mobile device is operable to wirelessly communicate, directly, with associated machines, vehicles, electronics, etc., to request initiation of preassigned (authorized) actions, when communications with a central location/base computer processing means is lacking or unavailable. In such an event, it is desired to enable the mobile device to report the current or impending emergency situation, event, situation, initiation commands, etc., to the central location/computer processing means when wireless communications are restored.

It is another object of the present invention to provide a wireless network and/or internet protocol-based action-oriented mobile device, and system containing same, to allow a user, via a mobile device, to remotely notify a central location/computer processing means of a current or impending emergency situation, event, situation, initiation commands, etc., when the mobile device is out of direct communications range of the central location/computer processing means, via an ad hoc network formed by one or more mobile devices and/or access points. The central location/base computer processing means will, subsequently, wirelessly communicate with associated machines and/or vehicles to request initiation of preassigned actions thereby.

It is a further object of the present invention to provide a wireless network and/or internet protocol-based action-oriented mobile device, and system containing same, to allow a user, via a mobile device, to initiate predetermined/preassigned actions for machinery, vehicles, electronics, etc., when the system detects that a mobile device is in geographical proximity to the machinery, vehicles, electronics, etc.

It is a further object of the present invention to provide a computer software program product for use in the mobile device and system described above, to achieve the above-mentioned actions.

It is yet a further object of the present invention to provide each mobile device in the system with a barcode, unique identification number and/or service-subscriber key which allows the base station computer application program code to determine the identity and authorized initiation commands of each individual mobile device.

### SUMMARY OF THE INVENTION

In order to achieve the above mentioned objects, the present inventors earnestly endeavored to provide an improved system for wireless network and/or internet protocol-based action, a computer program product used therein, and a method for wirelessly alerting/communicating an action initiation command to authorized machines, vehicles, electronics, etc. directly or via a central location/computer processing means, so as to initiate a preassigned/preauthorized action. Accordingly, in a first embodiment of the present invention, a wireless network-based action-oriented system is provided, comprising:

(1) one or more internet protocol-based and/or identifiable telecommunication mobile devices, each mobile device comprising:
(a) one or more of an active RFID chip operable to transmit a MAC address on an internet protocol-based wireless network, a subscriber identity module (SIM) card having a service-subscriber key, mobile identification number (MIN), or other device identification means;
(b) a mobile computer processing means (such as a conventional computer processor) in communication with one or more of the active RFID chip, SIM card, MIN or other identification means;
(b) a user alert initiation means in communication with the one or more of the active RFID chip and the mobile computer processing means, so as to allow communication of one or more action initiation commands by a user to the mobile computer processing means;
(c) a mobile wireless communication means in communication with the active RFID chip and/or mobile computer processing means;
(d) one or more sensors/detectors operable to detect/measure physical and/or biological parameters, the sensors/detectors in communication with the mobile computer processing means; and
(e) one or more sensor/detector-based initiation means in communication with the mobile wireless communication means and/or mobile computer processing means, said sensor/detector-based initiation means operable to initiate communications with the mobile device based on the detected/measured physical and/or biological parameters, so as to allow communication of data sensed/detected by one or more of the sensors/detectors;

(2) one or more stationary and/or mobile base stations, each of said base stations in wireless communication with one or more of the mobile devices, each of said base stations comprising:
(a) a base station computer processing means;
(b) a computer storage means in communication with the base station computer processing means; and
(c) a base station wireless communication means in communication with the base station computer processing means, said base station wireless communication means operable to communicate with the computer processing means and one or more associated units (comprised of one or more of machinery, vehicles, electronics, etc.), the units comprising programmable logic controllers and/or wireless communication/computer processing means operable to receive and execute action initiation commands from one or more of base stations and/or mobile devices, said associated units being associated with a corresponding mobile device;

(3) a mobile computer application program product operable to run on the mobile computer processing means, alone or in conjunction with a conventional operating system, comprising:
(a) computer application program code operable to communicate one or more of said action initiation commands from the user alert initiation means, and the sensed/detected data, to the active RFID chip and/or to the mobile wireless communication means; and
(b) computer application program code operable to enable transmission of one or more action initiation commands and the sensed/detected data to one or more of a base station, access point and mobile device via the active RFID chip, and/or via an authenticated wireless transmission via the mobile wireless communication means;

(4) a base station computer application program product operable to run on the base station computer processing means, alone or in conjunction with a conventional operating system, comprising:
(a) computer application program code operable to enable reception of the action initiation command and the sensed/detected data directly from the mobile devices and/or from one or more access points associated with one or more of the mobile devices, and transmit same to the base station computer processing means;
(b) computer application program code operable to enable the base station computer processing means to determine an identity of one or more of the mobile devices via identification of the active RFID chip, the service-subscriber key of the SIM therein, and the MIN, and physical (geographical) location of one or more of the mobile devices;
(c) computer application program code operable to determine an identity of units associated with a mobile device, based on the identified active RFID tag, service-subscriber key of the SIM, MIN or other identification means of the identified mobile device, user of the mobile and/or the determined physical (geographical) location of the mobile device;
(d) computer application program code operable to query a cache of action initiation data, stored on the base station computer storage means or accessible by the base computer processing means, corresponding to the associated units determined in (c) above, to determine one or more appropriate action initiation commands associated with the determined associated units;
(e) computer application program code operable to enable the base station computer processing means to communicate, via the base station wireless communication means or other means, the action initiation commands to the associated units; and
(f) computer application program code operable to transmit data to a user interface means to enable observation of system conditions, and select active controls (action initiation commands) for specific mobile devices and/or the associated units.

In a second embodiment of the present invention, the wireless network-based action-oriented system of the first embodiment above is provided, wherein the mobile device further comprises a GPS device in communication with the mobile wireless communication means. The GPS device is operable to communicate the geographic location of the mobile device to the base station(s).

In a third embodiment of the present invention, the wireless network-based action-oriented system of the first embodiment above is provided, wherein the mobile device further comprises a trigger device to initiate communications with the mobile device based on the detected/measured physical and/or biological parameters.

In a fourth embodiment, the wireless network-based action-oriented system of the first embodiment above is provided, further comprising one or more stationary and/or mobile system access points in wireless communication with one or more of the mobile devices and one or more of the stationary and/or mobile base stations, the access points operable to extend the communications range of the mobile devices with the base stations. Each of said access points comprises a computer processing means, and a wireless communication means, said access points capable of communicating with the mobile devices and the stationary and/or mobile base stations.

In a fifth embodiment, the wireless network-based action-oriented system of the first embodiment above, wherein the mobile device further comprises a graphical user interface in communication with the mobile computer processing means, the graphical user interface operable to display to the user one or more authorized action initiation commands.

In a sixth embodiment of the present invention, the wireless network-based action-oriented system of the first embodiment above is provided, wherein the mobile device further comprises a biometric identification means in communication with mobile computer processing means.

In a seventh embodiment of the present invention, the wireless network-based action-oriented system of the first embodiment above is provided, wherein the sensors/detectors comprise one or more of a pressure sensor, accelerometer, gyroscope, motion detector, infrared (IR) distance sensor, light sensor (light meter), radioactivity detector/sensor, chemical sensor, physiological parameter sensor, biometric sensor, bioagent detectors, altimeter, air speed indicator, air pressure sensor, olfactory sensor, and acoustic detector. The sensors/detectors may be provided within the mobile device, or physically separate from the mobile device. The sensors/detectors are operable to communicate physical and/or biological data to the actuator computer processing means, which then communicates said data (or variations thereof) to the base station computer processing means. The base station computer processing means is operable to initiate a warning or communication to preselected individuals, and/or communicate commands to machinery associated with the actuator from which the data was received, based on the data communicated from the sensors/detectors.

In an eighth embodiment of the present invention, the wireless network-based action-oriented system of the first embodiment above is provided, wherein the mobile device further comprises one or more light emitting devices, including but not limited to light emitting diodes (LED's), disposed thereon.

In a ninth embodiment of the present invention, the wireless network-based action-oriented system of the first embodiment above is provided, wherein the mobile device further comprises a power source in communication with the mobile device computer processing means. This power source may be any conventional disposable or rechargeable power source. Alternatively, the power source may be operable to remotely power the mobile device.

In a tenth embodiment of the present invention, the wireless network-based action-oriented system of the first embodiment is provided, wherein the mobile device further comprises a reactive device housing, which may be wholly or partially comprised of a polydiacetylene-containing polymer.

In an eleventh embodiment of the present invention, the wireless network-based action-oriented system of the first embodiment is provided, wherein the base station computer application program product further comprises:

computer application program code operable to associate the service-subscriber key and/or mobile identification number (MIN) of each mobile device with a user identification (including one or more of, but not limited to, name, picture, address, title, biometric data, etc.);

computer application program code operable to correlate user identifications with one or more corresponding authorized action initiation commands; and

computer application program code operable to enable transmission of authorized mobile device action initiation commands to corresponding units.

In a twelfth embodiment of the present invention, the wireless network-based action-oriented system of the tenth embodiment above is provided, wherein the base station computer application program product further comprises:

computer application program operable to automatically alter authorized mobile device action initiation commands associated with the service-subscriber key, MIN, or other identification means of each individual mobile device based on the geographical location of mobile devices.

In a thirteenth embodiment of the present invention, the wireless network-based action-oriented system of the tenth embodiment above is provided, wherein the base station computer application program product further comprises:

computer application program operable to automatically alter authorized mobile device action initiation commands associated with the service-subscriber key of each individual mobile device based on the geographical location of mobile devices.

In a fourteenth embodiment of the present invention, the wireless network-based action-oriented system of the first and tenth through twelfth embodiments above is provided, wherein the base station computer application program product further comprises:

computer application program code operable to automatically transmit preassigned action initiation commands to corresponding units based on the geographical location of a mobile device.

In such an embodiment, the user or system administrator may preassign action initiation commands for units corresponding to individual mobile devices. Then, when a mobile device comes within a predefined physical proximity of a corresponding unit, the base station, when sensing same, automatically transmits one or more action initiation commands to the appropriate corresponding units.

In a fifteenth embodiment of the present invention, the wireless network-based action-oriented system of the fifth and thirteenth through fourteenth embodiments above is provided, wherein the mobile computer application program product further comprises:

computer application program code operable to receive authorized action initiation commands; and

computer application program code operable to display the authorized action initiation commands on the graphical user interface.

In a sixteenth embodiment of the present invention, the wireless network-based action-oriented system of the fifth and thirteenth through fifteenth embodiments above is provided, wherein the mobile computer application program product further comprises:

computer application program code operable to receive altered (revised) authorized action initiation commands; and

computer application program code operable to reconfigure the displayed authorized action initiation commands on the graphical user interface, so as to display the altered authorized action initiation commands.

In a seventeenth embodiment of the present invention, the wireless network-based action-oriented system of the fourth embodiment above is provided, wherein the mobile computer application program product further comprises:

computer application program code operable to display current associated units authorized to receive action initiation commands from the mobile device on the graphical user interface thereof, and

functions of said associated units and/or authorized action initiation commands for each of said associated units.

In an eighteenth embodiment of the present invention, the wireless network-based action-oriented system of the first through seventeenth embodiments above is provided, wherein the mobile computer application program product and/or the base station computer application program product further comprise:

computer application program code operable to enable ad hoc networking of the mobile devices and/or base stations with one another, so as to extend the wireless communications range of system components (mobile devices and base stations).

In a nineteenth embodiment of the present invention, the wireless network-based action-oriented system of the sixth embodiment above is provided, wherein the mobile computer application program product and/or the base station computer application program product further comprise:

computer application program code operable to correlate biometric data of a user received from the biometric identification means with one or more of an active RFID chip, service-subscriber key and mobile identification number (MIN), so as to identify a user of the mobile device; and

computer application program code operable to correlate one or more of an active RFID chip, service-subscriber key and MIN, with one or more action initiation commands authorized for the identified user of the mobile device.

In a twentieth embodiment of the present invention, the wireless network-based action-oriented system of the first and second embodiments above is provided, wherein the associated units comprise:

(a) a unit computer processing means;

(b) a unit station wireless communication means which is in communication with the unit computer processing means, said unit wireless communication means operable to enable wireless communication of the unit computer processing means with one or more stationary and/or mobile base stations, access points and/or one or more mobile devices; and

(c) a unit computer application program product operable to run on the unit computer processing means, alone or in conjunction with a conventional operating system, comprising:
(1) computer application program code operable to enable reception of the action initiation command from one or more of the base stations, one or more access points and one or more mobile devices;
(2) computer application program code operable to determine status of the unit at the time of receipt of the action initiation command;
(3) computer application program code operable to enable the unit computer processing means to transmit an execution order of the action initiation command, based on the determined status of the unit at the time of receipt of the action initiation command, to the unit; and
(4) computer application program code operable to enable the unit computer processing means to communicate the status of the unit after execution of the action initiation command to one or more of the base stations directly or via one or more access points and/or mobile units.

In a twenty first embodiment of the present invention, the wireless network-based action-oriented system of the first through twentieth embodiments above is provided, wherein the wireless network is one or more of an interne protocol-based wireless network and a wireless mobile telecommunication network.

In a twenty second embodiment of the present invention, the wireless network-based action-oriented system of the first through twentieth embodiments above is provided, wherein two or more of the mobile devices, access points and base stations are operable to form an ad-hoc wireless network.

In particular, the mobile device may be quickly associated to an asset (such as machinery) or person by utilizing near field or contact association. This is achieved by first associating a barcode or readable identification means with the active RFID contained in the actuator, and scanning/electronically inputting the barcode and/or other readable identification means associated with the active RFID tag, SIM card, MIN, etc., contained within the mobile device, so as to input the barcode, associated active RFID, service-subscriber key, MIN, etc., into the base station computer storage means, as described above.

In a further embodiment of the present invention, the wireless network-based action-oriented system of the second embodiment above is provided, wherein the mobile device is auto-programmable via passive RFID, near field RFID technology and/or wireless or wired execution of computer application program code operable to program authorized action initiation commands, associated units (i.e. units authorized to be controlled by the mobile device/user thereof). The passive RFID tag may be embedded in the mobile device, and the auto-programming computer application program code may be stored on the base station and/or mobile device for execution by the base station and/or mobile computer processing means.

As discussed above, the internet protocol-based action orientated actuator (i.e., actuator), which may be worn by a user, may be activated by the user to wirelessly communicate a signal to a wireless network subsequently initiating an assigned action stored on the central server. The system includes a computer software program product (application) located on a base station server, which links the mobile devices through a wireless network to communicate with a corresponding unit(s) to initiate an authorized action thereby. Further, such an action may be intentionally (actively) initiated, or automatically initiated based upon sensed/detected data. The mobile device may contain a barcode, or a unique identification number, that is initially assigned by the application on the base station to initiate subsequent action on a third party device. For example, a mobile device may be assigned (authorized) to deactivate a certain machine, vehicle or electronic, both actively and passively.

The computer application program product may comprise computer application program code operable to associate the barcode, or unique identification number, of each individual mobile device with the active RFID tag, SIM card, MIN, identity of the user, etc., thereof. Thus, the mobile device, in conjunction with the system and corresponding computer program product, allows a user to have the ability to immediately initiate a remote action, such as the halting of operation of industrial equipment or vehicles in communication with the system.

### BRIEF DESCRIPTION OF THE DRAWINGS

FIG. 1 is a box diagram illustrating the architecture of the wireless network-based action-oriented system of the present invention.

FIG. 2 is a box diagram, illustrating the connectivity of the mobile devices to the system, the flow of data, and the interrelationship of the system components.

FIG. 3 is a perspective view of an exemplary mobile device of the wireless network-based action-oriented system of the present invention.

FIG. 4 is a box diagram illustrating an exemplary embodiment of the mobile device, wherein the sensors/detectors are physically attached to the mobile device.

### DETAILED DESCRIPTION OF THE INVENTION

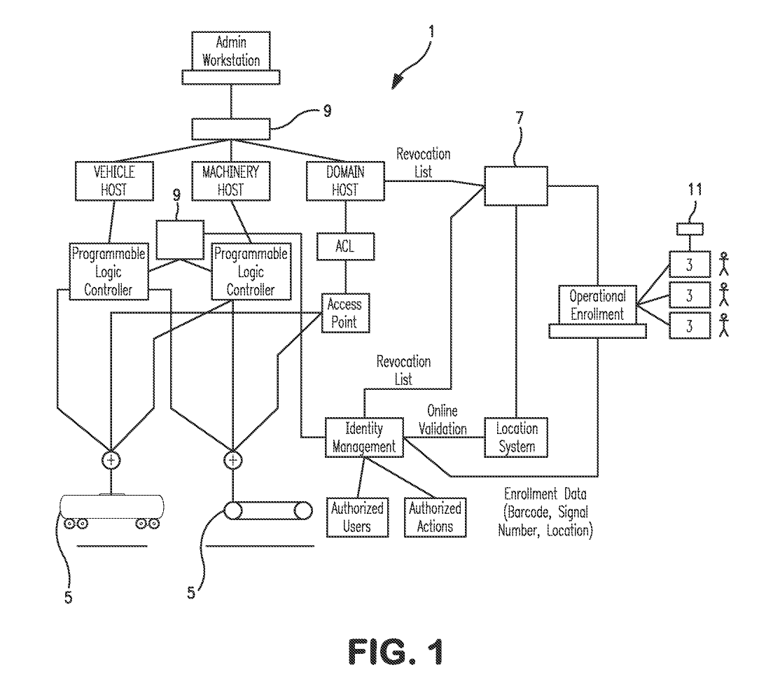

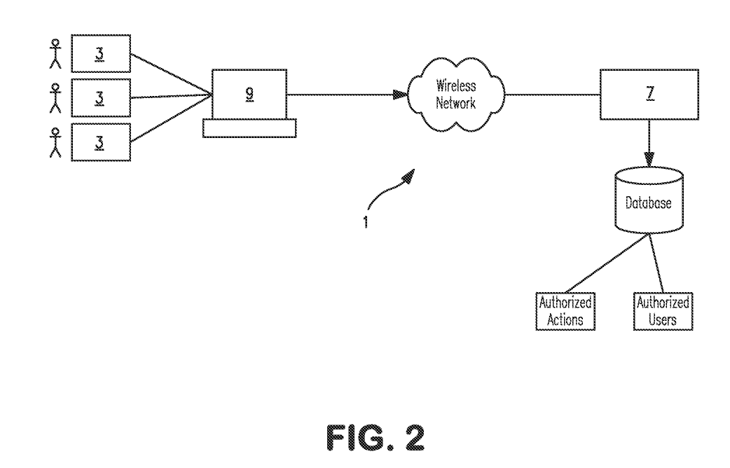

As illustrated in FIGS. 1 and 2, the present invention provides a wireless network-based action-oriented system 1, as described in the first embodiment above, wherein one or more mobile devices 3 are provided to wirelessly communicate authorized action initiation commands to machinery, vehicles, electronics, systems, etc. 5, which are associated with the mobile device 3, via one or more base stations 7, and optionally via access points 9 operable to extend the communications range of the network. The associated machines, vehicles, electronics, systems, etc., 5 are not limited to any specific device, but rather may be any device or system capable of being remotely controlled. Hereinafter these associated machines, vehicles, electronics, systems, etc., are referred to as “associated units”.

As mentioned above, the present invention operates via a wireless network. Generally, a conventional wireless network, such as a TCP/IP Wireless 802.11b network, a Wireless Personal Area Network (WPAN) such as Bluetooth®, Wireless LAN, WiMAX, a Wireless Wide Area Network (WWAN), etc., is required for minimum use capability of the system of the present invention, but any present or future conventional wireless network standard may be utilized that is capable of transmitting the action initiation commands, sensed/detected data of the present invention.

As mentioned above, the system also contains one, or a plurality of, base stations, each of which may be stationary and/or mobile. For example, a base station may be a fixed (stationary) server, or may be mounted within a vehicle so as to provide a mobile network capability. The base stations each comprise a base station computer processing means, such as a conventional microprocessor. Generally, an IBM or compatible PC workstation running a Microsoft Windows or LINUX operating system is required for minimum use capability of the system of the present invention, but any conventional CPU may be utilized.

A computer storage means may be in fixed or wireless communication with the base station computer processing means. Further, each base station has a base station wireless communication means, such as an Ethernet chip, wireless transmitter/receiver, etc., which is in communication with the base station computer processing means and which enables wireless communication of the base station with one or more of the mobile devices, access points and associated units. The base station computer processing means may be programmed to automatically transmit action initiation commands to one or more associated units upon receipt and analysis of data from one or more mobile devices.

For example, the base station computer program product may be comprised of computer application program code operable to transmit a warning to a warehouse manager when data is received from a mobile device containing an air speed indicator, which indicates that a worker whose MAC address is associated with lack of certification to operate a forklift is exceeding a predetermined velocity. Alternatively to, or in addition to same, the base station may transmit an action initiation command to the forklift (i.e., unit) to limit the velocity thereof, and/or disable operation of the forklift. However, there is no limitation to the actions capable of being initiated by base station computer processing means based on the sensed/detected data received thereby. For example, if forklifts are in communication with the system of the present invention, the base station computer processing means may be operable to cease operation of all forklifts detected in close proximity to the uncertified user. Accordingly, preferably, the units comprise programmable logic controllers, which enable execution of the action initiation commands, or other conventional mechanical, electromechanical or electronic means of enablement therefor.

In a preferred embodiment, the mobile devices are internet protocol-based and/or identifiable wireless telecommunication action orientated mobile devices. Each mobile device preferably has an active RFID chip operable to transmit a MAC address on a wireless network, and/or a subscriber identity module (SIM) card having a service-subscriber key, mobile identification number (MIN) or other code (i.e., a numerical code, digital code, etc.) that the system may utilize to identify a user, an individual mobile device or both. Specifically, the MAC address, service-subscriber key, MIN, etc. of each mobile device enables the system to identify each individual mobile device, as well as, alternatively, the identity of the user of the mobile device. The user/mobile device identification can then be correlated to action initiation commands authorized to be transmitted/executed by the user/mobile device.

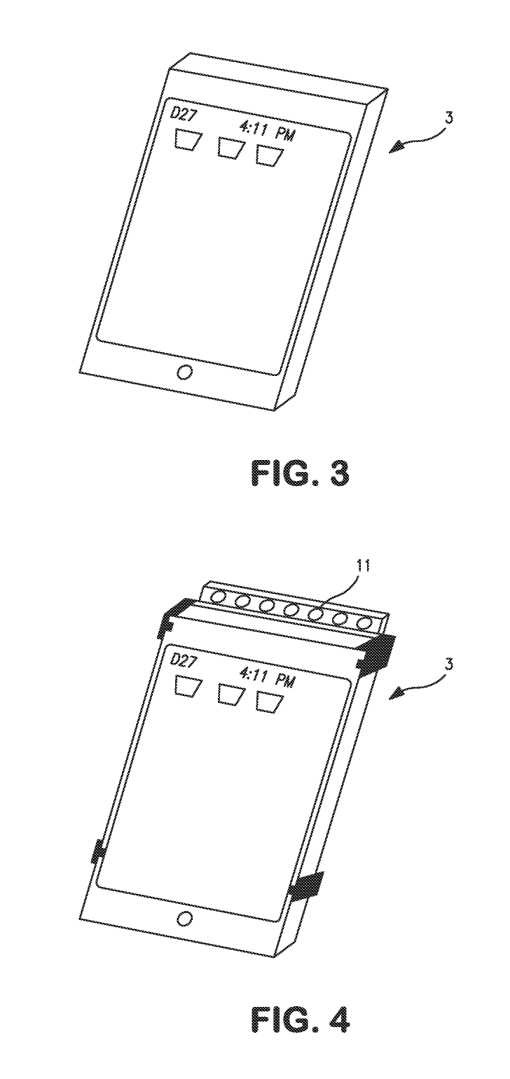

The mobile device may be a specialized device tailored specifically to the system of the present invention. For example, the mobile device may be a custom-made small, portable electronic device comprising a mobile computer processing means in communication with the active RFID chip and/or SIM card and/or MIN; a user alert initiation means; a mobile wireless communication means in communication with the active RFID chip and/or mobile computer processing means; one or more sensors/detectors operable to detect/measure physical and/or biological parameters, the sensors/detectors disposed on, within or in communication with the mobile computer processing means; and one or more sensor/detector-based initiation means, as called for above. In a preferred embodiment, as illustrated in FIG. 3, the mobile device 3 is a conventional smart phone, such as an APPLE® iPhone®, running the mobile computer program product of the present invention.

When the mobile device is a MAC (Media Access Control) addressable device, the mobile device is comprised of an active RFID (radio frequency identification) chip and a user alert initiation means, such as a button, switch or graphical user display displaying virtual representations of same, in communication with the active RFID tag, so as to allow the user to send one or more action initiation commands to the mobile device computer processing means by simply depressing/touching/activating a button, switch or virtual equivalent thereof.

In an internet protocol-based mobile device, a mobile wireless communication means, such as an Ethernet card, is provided in communication with the RFID chip. In another preferred embodiment, wherein a service-subscriber key, MIN, or other coded means of identification, is utilized as the means of identification and correlation mechanism for authorized action initiation commands, conventional wireless telecommunications networks may be utilized. In such a preferred embodiment, generally, the mobile device contains a GPS chip to enable geographic location determination of the mobile device on the network.

For example, in practice, the mobile device is a smartphone comprised of one or more of an RFID chip, a service-subscriber key (which may be stored on SIM card) or some other type of mobile identification number (MIN) that identifies a user; one or more of a TCP/IP ethernet Chip, conventional wireless receiver/transceiver; ASIC; static RAM; a housing comprised, generally, of plastic or polymeric materials; and a graphical user display, such as an LCD screen, acting as the action initiation means. The mobile device has both transmit and receive functions, such that the mobile wireless communication means allows the mobile device to communicate with the base station directly, with the base station via the closest system access point, or with the base station via an ad hoc network formed by one or more mobile devices, access points, mobile base stations, etc. The access points are generally wireless network bridge devices, whereas the mobile devices may be virtually any mobile device comprising the components described above, and running the mobile device computer product called for herein.

Further, the mobile device has a mobile wireless communication means in communication with the mobile computer processing means, and a passive and/or active trigger mechanism to initiate communications with the mobile device based on detected/measured physical data and/or biological parameters detected/measured by one or more sensors/detectors provided on the mobile device. Preferably, the mobile devices also comprise a barcode and/or a unique identification number, such as a service-subscriber key, mobile identification number, etc.

Alternatively, in a preferred embodiment, each mobile device comprises a SIM card, MIN, etc. (i.e., a coded means of identification) in communication with the mobile computer processing means (i.e., computer microprocessor), without an active RFID tag. In such an embodiment, the service-subscriber key, MIN, etc. is utilized to identify to the network the user of the mobile device. Further, a user alert initiation means is provided in communication with the mobile computer processing means, so as to allow communication of one or more action initiation commands by a user to the mobile computer processing means. The user alert initiation means, such as a button, switch or graphical user display displaying virtual representations of same, is in communication with the mobile computer processing means, so as to allow the user to send one or more action initiation commands to the mobile computer processing means by simply depressing/touching a button, switch or virtual equivalent, shaking the mobile device, or some other alternative means of activation.

The mobile device may be auto-programmable via passive RFID or near field RFID technology, or via downloading of computer application program code via the wireless network. In particular, the mobile device may be quickly associated to a unit (such as machinery) or person by utilizing near field or contact association. This is achieved by first associating a barcode with the active RFID contained in the mobile device, and scanning the barcode associated with the active RFID tag contained within the mobile device, so as to input the barcode and associated active RFID into the base station computer storage means, as described above. Then, the barcode and active RFID to a user via the base station computer processing means. Alternatively, the system may wirelessly detect the identification of the mobile device via the service-subscriber key, MIN, or other similar identification means, and correlate same to a user via manual or automatic computer application programming means.

Sensors/detectors operable to detect/measure physical data and/or biological parameters are provided in communication with mobile computer processing means and/or the base stations. The sensors/detectors 11 may be integrated into the mobile device, or physically attached to the mobile device, via a frame, case, etc., as illustrated in FIG. 4. Alternatively, the sensors/detectors 11 may be disposed remotely from the mobile device, but in wireless communication therewith via a conventional means of wireless communication (such as Bluetooth®, IR transmission, etc.), as illustrated in FIG. 4.

As mentioned above, the sensors/detectors may be one or more of a motion detector, infrared (IR) distance sensor, light sensor (light meter), radioactivity detector/sensor, chemical sensor (such as, for example, a CO sensor, gas detector, etc.), physiological parameter sensor, biometric sensor, bioagent detectors, altimeter, air speed indicator, air pressure sensor, olfactory sensor, accelerometer, thermometer (which may be utilized to detect, for example, fires, overheating machinery, malfunctioning air conditioning systems, etc.).

In operation, the sensors/detectors transmit sensed/detected data to the mobile device and/or the base stations (base computer processing means). When receiving data from the sensors/detectors, the base computer processing means queries the cache of action initiation data to determine an appropriate response (such as an action initiation command, or the decision to take no action) based on the data received from the sensors/detectors. Exemplary action initiation command include, but are not limited to, enabling operation of one or more of the associated units (machinery, vehicles, electronics, etc.), which may be executed via electronic means, programmable logic controllers, or other conventional means of operation. The action initiation command may further result in disabling operation thereof, initiating operation thereof, and/or transmitting warnings to individuals/mobile devices or organizations in communication with the system of the present invention.

The sensors/detectors may be actively initiated by the user to sense/detect physical, atmospheric and/or biological parameters. For example, an olfactory sensor may be activated at will by a user to detect/measure scents in the immediate atmosphere. Then, the olfactory sensor transmits the sensed/detected olfactory data to the mobile computer processing means (i.e., mobile computer processor). Thereafter, the sensed/detected olfactory data is sent to one or more base stations, wherein the data is analyzed, appropriate authorized action initiation command(s) are determined, and action initiation commands are transmitted to the appropriate corresponding units if needed.

Alternatively, the sensors/detectors may be programmed to function automatically/autonomously (i.e., independent of human action) as well, wherein the sensors/detectors constantly or periodically sense/detect predefined physical, atmospheric and/or biological parameters. When a particular detected/measured parameter is detected/measured within a certain predetermined threshold, a data message containing the detected/sensed data is transmitted to the mobile computer processing means. The mobile device then transmits the detected/sensed data to one or more base stations, and the network takes appropriate action as described in the above embodiment. Namely, the base station computer processing means are operable to initiate a warning or communication to preselected individual mobile devices, and/or communicate action initiation commands to units associated with the mobile device(s) from which sensed/detected data was received.

For example, if the mobile computer processing means, receiving data from the motion detector, determines that the mobile device has been sedate (not moved) for a specified period of time during specified hours, the mobile device is operable to send a warning signal to the base station computer processing means of the system of the present invention. The base station may then determine that the appropriate action initiation command is a command to automatically transmit an event or warning communication to specified people/units. For example, the system could trigger a “Man Down” alarm, deactivate associated units such as machinery, vehicles, etc. in proximity to the mobile device, or simply notify a foreman associated with the specific mobile device that the user associated with that mobile device has not moved for a specified time period.

Thus, in general, when analyzing and acting upon any sensed/detected data from the sensors/detectors provided by the present invention, the base station computer processing means receives data from the mobile device provided by the sensors/detectors (or directly from the sensors/detectors), queries a cache of action initiation data to determine an appropriate response thereto (such as an action initiation command, or the decision to take no action) based on the data received from the sensors/detectors. Exemplary action initiation command include, but are not limited to, enabling operation of one or more of the units, disabling operation thereof, and transmitting warnings to individuals or organizations in communication with the system of the present invention.

For example, if a temperature sensor detects a temperature within a predefined temperature threshold range, the detected temperature data is transmitted to the mobile device in communication therewith. The mobile device then transmits the sensed/detected temperature data to a base station for analysis and action thereon. The base station may the verify that the temperature is within a predefined temperature threshold range associated with the mobile device, and if so, determine the appropriate action to take based thereon, and then send an action initiation command to an air conditioning unit in proximity to the corresponding mobile device, so as to decrease the temperature in the location adjacent the mobile device.

The air speed indicator is capable of measuring the velocity (via air speed) of travel of the mobile device, and thus the user. Inclusion of the air speed detector on the mobile device is preferred in situations in which velocity of the user is controlled by certifications and/or qualifications. For example, in warehouse applications, operation of a forklift requires training and certification prior to same. However, frequently, uncertified workers operate forklifts, placing others in danger and potentially causing the company liability for damages resulting from accidents.

When data is received from the mobile device comprising the air speed indicator, which indicates that a worker whose MAC address, service-subscriber key, MIN, etc. is associated with a lack of certification to operate a forklift, is exceeding a predetermined velocity, the base station computer processing means is operable to initiate an appropriate action, i.e., transmit an authorized action initiation command. For example, the base station computer processing means may be operable to send a warning to the warehouse foreman, so that the foreman can take action. Alternatively, the base station computer processing means may be operable to turn off one or more forklifts via programmable logic controllers communication therewith in close proximity or associated with the MAC address of the RFID of the mobile device, geographic location of the SIM card/MIN enabled mobile device, based upon the data received from the air speed indicator.

The light sensor (light meter) is operable for detecting the presence and/or level of light incident on the sensor. The light sensor may be configured to detect light within specified regions, depending upon the application. For example, the light sensor may be capable of detecting infrared light, visible light, etc. The mobile computer application program product is be operable to initiate an action initiation command from the user alert initiation means to the active RFID tag and/or mobile computer processing means (for SIM card/MIN enabled devices) if no light is sensed/detected for a preassigned period of time. This action initiation command, which may be overridden by the user, may operate to automatically turn on lights in a room when the mobile device enters the room, turn off lights when the light sensor detects a level of light higher than a predefined light level range, etc. Thus, the mobile device may be programmed to initiate any desired action based on data communicated by the light sensor.

In the case of a heat sensor provided on or within communications range of the mobile device may be functional not just to determine temperature, but to transmit a data identifier to the mobile computer processing means of the mobile device when a specified pre-programmed time limit has been reached at a certain temperature. As mentioned above, various other sensors/detectors may be provided, and although obviously for a different application than the heat sensor, such sensors/detectors may also function so as initiate a predetermined action based on physical/biological parameters sensed/detected by same.

For example, when an altimeter is provided, capable of detecting the altitude of the mobile device, the mobile device is operable to communicate altitude data to the mobile computer processing means, for communication to the base station computer processing means. Data received from the altimeter may be utilized by the base station computer processing means to determine, for example, whether one or more individuals associated with the mobile device which transmitted the altitude data are performing an unauthorized function, or are in an unauthorized location. Specifically, the base station computer processing means, in conjunction with the base station computer application program product, may receive altimeter data from the mobile device, query a database containing data concerning qualifications/certifications of the user of the mobile device concerning authorized locations of the user of the mobile device, and therefore determine, for example, whether the individual using the mobile device may be getting on a long ladder or forklift basket cage for work high in the air without permission.

The biometric sensor allows for direct association of the mobile device to the user. In particular, the biometric sensor is operable to measure biometrics of the user, such as fingerprint, vein patterns of the eye, etc. The biometric sensor then communicates this biometric data to the mobile computer processing means, which then communicates same to one or more base stations. The base station computer processing means then queries a cache of action initiation data and user identification data, to determine, for example, who the user is, whether the user is authorized to use the mobile device, whether the user is authorized to be in the area of the mobile device, etc. Direct biometric association to the mobile device may require external power during the moment of association if the biometric is built into the mobile device.

A user may be required to biometrically associate with the base station computer processing means, or directly biometrically associate with the mobile device, thereby allowing the system to unilaterally identify the person with that mobile device. For example, a user may log into the base station computer application or register as an active user. Then, the user may lay his mobile device on an RFID near field antenna, so as to read the RFID on the mobile device and associate it with the user. Alternatively, the network can identify the mobile device via the service-subscriber key, MIN, etc., and the user thereof can be associated with the identified mobile device via manual data input into the base computer processing means, or via automatic correlation of a user to the mobile device via any conventional electronic means.

When the mobile device is utilized in an environment that requires detection of sound data, as mentioned above, the mobile device may comprise an acoustic detector. The acoustic detector is operable to receive and record streaming audio data for transmission, and transmit the streaming audio data to the mobile computer processing means. The mobile computer processing means then transmits the streaming audio data to the centralized server/base station.

In addition, the mobile device having an acoustic detector may be configured to be operable to detect and transmit identifiers associated with specific noises. For instance, specific drivers of forklifts may change gear much more frequently than others. The mobile computer processing means can be programmed to detect specified sound frequencies created by the changing of gears, interpret the gear change sound frequency as a Boolean value, and transmit that value to the base station. The base station then queries the cache of action initiation data, and determines an appropriate action. For example, a warning concerning excessive gear changing by the user associated with a particular mobile device may be transmitted to the warehouse foreman.

In an alternative preferred embodiment, the acoustic detector may function to detect and transmit sound level data to the mobile computer processing means and/or base station processing means. Then, the base station compares the level of sound to a preassigned/predetermined sound threshold range. If the sound is below or above the preassigned/predetermined sound threshold range, the base station can transmit an action initiation command to associated units in proximity to the mobile device so as to alter the sound level adjacent the user of the mobile device. This application may be utilized to, for example, increase the sound level of televisions, radios, etc., for the hearing impaired, reduce dangerous sound levels which may damage hearing, etc.

In contrast to the embodiments described above for transmitting data to the system, the mobile device may have a housing formed partially or wholly of a reactive polymer, which changes color upon exposure to physical changes, so as to transmit data/alert the user of the mobile device of certain situations. Specifically, the housing may be formed of a polydiacetylene-containing polymer which undergoes a visible color change upon exposure to a variety of elements, including ultraviolet light (UV) or physical stress. In such an embodiment, the mobile device housing acts as a sensor/detector, so as to be operable to warn the user of undesirable exposure (or lack thereof) to UV light, or other physical stresses which affect the housing polymer.

In a preferred embodiment, the mobile device has one or more light emitting means, such as LED's, disposed thereon. In practice, the mobile device preferably has a series of light emitting diodes disposed thereon for display to a user, the LED's representing a time constraint chosen by the application administrator. This application requires a button, switch or virtual representation of same on the graphical user display of the mobile device to be pressed at the end of a determined event by the operator. The LED's displayed in, for example, a circle pattern, light up as the preprogrammed time constraint is nearing completion.

With regards to power sources, the mobile device may have a traditional power source, such as a disposable or rechargeable battery. However, preferably, the mobile device is powered by a piezoelectrically rechargeable power source, which negates the need for recharging, but rather depends on simple motion of the mobile device. Further, the power source may be configured so as allow for induction charging, thereby negating the need for physical contact between the mobile device and the charger device.

In another preferred embodiment, the power source for the mobile device is remote therefrom, and is operable to remotely power the active RFID tag of the mobile device. In such an embodiment, the power source is the base station computer processing means, a remote power source in communication therewith, or an electronic device not in communication with the system of the present invention. For example, the active RFID tag of the mobile device, when placed in the vicinity of, but not in direct contact with, the remote power source, is powered via heat energy or permanent magnet-excited transverse flux electrical energy emanating from the remote power source. Thus, the mobile device would never need to be charged.

In a further preferred embodiment, the system further comprises one or system access points, so as to extend the connectivity range of the mobile devices with the system. The access points are disposed within the system such that they are capable of being in wireless communication with one or more of the mobile devices and/or base stations. Each of the access points comprises an access point computer processing means, such as a microprocessor, and an access point wireless communication means, such as an ethernet chip or other conventional wireless communications means.

The mobile device is provided with a mobile device computer application program product operable to run on the actuator computer processing means, to enable the mobile device to communicate with the base station, sensors/detectors and user via the graphical user display. Preferably, the mobile computer application program product runs in conjunction with a conventional operating system, but may be configured to run independently. The mobile computer application program product comprises computer application program code operable to communicate an action initiation command from the user alert initiation means and/or sensors/detectors to the active RFID tag and/or wireless communication means of the mobile device. The mobile computer application program code further has computer application program code operable to enable the active RFID tag to communicate an action initiation command to the base station computer processing means by transmitting a signal (such as a Boolean value, digital command, etc.) to the base station.

Likewise, the base station server is provided with a base station computer application program product operable to run on the base station computer processing means, independently or in conjunction with a conventional operating system. The base station computer application program product comprises computer application program code operable to enable reception of action initiation commands and sensed/detected data, received from the mobile devices, sensors/detectors and/or access points associated with the user's mobile device, and transmit same to the base computer processing means.

Further, computer application program code is provided which is operable to enable the base station computer processing means to determine the identification of the mobile device, the identification of the active RFID tag thereof, and/or physical location of the mobile device, based on the location of the mobile device on the wireless network. Alternatively, in a preferred embodiment, the physical/geographic location of the mobile device may be determined via receipt of data from the GPS chip preferably contained within the mobile device. Utilization of a GPS chip negates or minimizes the need for triangulation methods to determine the location of mobile devices on the network. Moreover, most conventional smartphones now comprise GPS chips, which enable ease of integration of same into the present system.

The base station computer application program product further comprises computer application program code operable to determine which units are associated with a mobile device on the network, based on the identified active RFID tag, service-subscriber key and/or MIN, and/or the determined physical location of the mobile device. Further, computer application program code is provided operable to query a cache of action initiation data, stored on the base station computer storage means or on a computer storage medium in communication with the base station, corresponding to the units associated with the active RFID tag, identity of the mobile device, or the location of the mobile device, to determine one or more appropriate action initiation commands associated with the determined associated units.

In addition, the base station computer application program product comprises computer application program code operable to enable the base station computer processing means to communicate, via the base station wireless communication means, the action initiation commands to the associated units, and computer application program code operable to provide a user interface means to enable observation of system conditions, and select active controls (action initiation commands) for specific mobile devices.

In addition to the computer application program product provided as part of the system of the present invention to run on the mobile device, and a base station computer application program product operable to run on the base station computer processing means, a unit computer application program product is provide, which is operable to run on the unit computer processing means of the units associated with the network, including those units comprising programmable logic controllers, as well as those units configured to execute action initiation commands via an alternative mechanical, electromechanical or electronic interface. These computer application program product elements, designed to run independently or in conjunction with conventional operating systems, allow the mobile device, access points, base stations and associated units to interface and communicate with each other.

The mobile computer application program product comprises computer application program code operable to communicate an action initiation command (i.e., via a depressing of a button, switch or virtual representation of same displayed on the graphical user interface of the mobile device) to the RFID tag and/or the wireless communications means, and computer application program code operable to enable the RFID tag and/or the wireless communication means to wirelessly relay that action initiation command directly to the base station computer processing means, or via the access points of the system.

In general, when receiving an action initiation command from a mobile device, the base computer application program product queries a database to determine the active controls (actions to be taken, including action initiation commands) that correspond to the identified RFID tag and/or the mobile device identified by the service-subscriber key, MIN, etc. The base station then sends action initiation commands to the units associated with the determined active controls. The system supervisor or other system management personnel may, via a user interface in communication with the base computer processing means, set the active controls associated with each particular mobile device. For example, each RFID tag, service-subscriber key, MIN, etc. (which correspond to a particular mobile device) can be assigned to a particular user, and also assigned to one or more associated units, such as machinery, vehicles, lighting systems within a building or room, electronics such as televisions and computers, air conditioning systems, etc., as described above.

In an exemplary embodiment of the functionality of the system, if the RFID chip is activated by the user, the RFID chip responds by transmitting a Boolean value to the base station. Alternatively, the user may transmit an action/command request to the base station via the graphical user interface, etc. The base station server then receives a “yes” or “no” signal from the RFID tag and/or mobile computer processing means, references which unit(s) the mobile device is associated with, and performs the necessary actions defined by the active controls. The actions may include, for example, sounding of a horn, turning on a light that requests more parts for the Kanban, automatically shutting down specifically assigned conveyors, turning on or off lights, air conditioning units, computers, etc.

The computer application program product may comprise computer application program code operable to associate the barcode, or unique identification number, of each individual mobile device with the active RFID tag, SIM card, MIN and/or user identification of each individual mobile device. Thus, the mobile device, in conjunction with the system and corresponding computer program product, allows a user to have the ability to immediately initiate a remote action, such as the halting of operation of industrial equipment or vehicles in communication with the system, the activation/deactivation of lighting, heating and cooling systems of a building, etc.

In practice, once the button (user alert initiation means) is pressed/activated by the user, or a sensor/detector transmits data, the mobile device wirelessly transmits a pre-set string of action initiation information, along with identification data concerning the mobile device, to the closest base station or access point on the wireless network, as illustrated in FIG. 1. This wireless transmission will continuously repeat this string of characters until the mobile device is reset by the base station server. The signal (comprised of an action initiation command) may be transmitted through the wireless network to an access point, which then transmits the packet of characters to a specified base station server. Alternatively, the signal may be transmitted by the mobile device directly to a base station in communication with the mobile device.

The base station server then performs the calculations defined in the base station server computer application program product description above, and thus transmits an action initiation command to the determined associated unit (i.e., those units associated with the active controls corresponding to the specific mobile device). Essentially, the base station server interprets the information received from the mobile device, determines one or more appropriate action initiation commands, and wirelessly transmits same to a corresponding unit so as to, for example, activate a corresponding programmable logic controller (PLC) in communication with the corresponding unit, that then terminates operation thereof, disables the unit, sends a warning or report to designated individuals, organizations or devices, etc.

Like the base stations and mobile devices, it is preferable that the associated units be supplied with a unit computer processing means, a unit computer storage means in communication with the unit computer processing means, and a unit station wireless communication means which is in communication with the unit computer processing means, and which is capable of enabling wireless communication of the unit computer processing means with the base station server. The associated units preferably comprise programmable logic control, or some other form of control. For example, the associated units may comprise a unit computer processing means, a unit computer storage means in communication with the unit computer processing means, and a unit station wireless communication means which is in communication with the unit computer processing means, and which is capable of enabling wireless communication of the unit computer processing means with the base station server.

In addition, unit computer application program product, operable to run on the unit computer processing means, in conjunction with a conventional operating system, is provided to enable the unit to communicate with the system, including receiving action initiation commands from the base station server or access points, determining the status of the unit, executing the action initiation commands received from the system, and transmitting the status of the unit to the system. The unit computer application program product comprises computer application program code operable to enable reception of action initiation commands from the base station computer processing means and/or mobile devices, computer application program code operable to determine the status of the unit at the time of receipt of the action initiation command, computer application program code operable to enable the unit computer processing means to transmit an execution order of the action initiation command, based on the determined status of the unit at the time of receipt of the action initiation command, to the unit, and computer application program code operable to enable the unit computer processing means to communicate the status of the unit after execution of the action initiation command to the system.

The system of the present invention is very easy to implement, as mobile devices can be distributed to staff of a particular facility that is already designed to support a wireless network for the entire establishment, or conventional mobile devices already carried by users, such as smartphones, can be easily integrated into the system. The mobile devices enable any individual that witnesses an emergency event, or spots irregularities that could be dangerous, to immediately notify the system electronically. Further, the mobiles device can be configured to support the control of location-based units, so as to control specific equipment, machinery, vehicles, electronics, etc. Thus, emergency stoppage of a particular accident or security violation in a given area can be expedited by the implementation of the system of the present invention. Further, units, such as air-conditioning and heating systems, lighting, security systems, can be controlled manually, or by assigning predetermined actions therefore, based on physical proximity of an associated mobile device with the units.

For example, an individual that is working on an assembly line may notice another worker getting caught in a conveyor belt, and find it much more responsive to press a button that is worn on his belt then having to run over to an area that has a work stop device, such as a “kanban”, mounted to it. Additionally, a person caught in a conveyor belt (or other such thing) may not be able to physically actuate a pull cord/push button that is physically mounted on the stationary machinery, but could reach the mobile device worn on or carried by the user. Further applications of the present invention include security in a bank, mall or any public “wireless” arena that could utilize a single action notification system to alert of an event

Although specific embodiments of the present invention have been disclosed herein, those having ordinary skill in the art will understand that changes can be made to the specific embodiments without departing from the spirit and scope of the invention. The scope of the invention is not to be restricted, therefore, to the specific embodiments. Furthermore, it is intended that the appended claims cover any and all such applications, modifications, and embodiments within the scope of the present invention.

What is claimed is:

1. A wireless network-based action-oriented system is provided, comprising:
(1) one or more internet protocol-based and/or identifiable telecommunication mobile devices, each mobile device comprising:
(a) one or more of an active RFID chip operable to transmit a MAC address on an internet protocol-based wireless network, a subscriber identity module (SIM) card having a service-subscriber key, mobile identification number (MIN), or other device identification means;
(b) a mobile computer processing means (such as a conventional computer processor) in communication with one or more of the active RFID chip, SIM card, MIN or other identification means;
(c) a user alert initiation means in communication with the one or more of the active RFID chip and the mobile computer processing means, so as to allow communication of one or more action initiation commands by a user to the mobile computer processing means;
(d) a mobile wireless communication means in communication with the active RFID chip and/or mobile computer processing means;
(e) one or more sensors/detectors operable to sense/detect physical and/or biological parameters, the sensors/detectors in communication with the mobile computer processing means; and
(f) one or more sensor/detector-based initiation means in communication with the mobile wireless communication means and/or mobile computer processing means, said sensor/detector-based initiation means operable to initiate communications with the mobile device based on the detected/measured physical and/or biological parameters, so as to allow communication of data sensed/detected by one or more of the sensors/detectors;
(2) one or more stationary and/or mobile base stations, each of said base stations in wireless communication with one or more of the mobile devices, each of said base stations comprising:
(a) a base station computer processing means;
(b) a computer storage means in communication with the base station computer processing means; and
(c) a base station wireless communication means in communication with the base station computer processing means, said base station wireless communication means operable to communicate with the computer processing means and one or more associated units, the units comprising programmable logic controllers and/or wireless communication/computer processing means operable to receive and execute action initiation commands from one or more of base stations and/or mobile devices, said associated units being associated with a corresponding mobile device;
(3) a mobile computer application program product operable to run on the mobile computer processing means, alone or in conjunction with a conventional operating system, comprising:
(a) computer application program code operable to communicate one or more of said action initiation commands from the user alert initiation means, and the sensed/detected data, to the active RFID chip and/or to the mobile wireless communication means; and
(b) computer application program code operable to enable transmission of one or more action initiation commands and the sensed/detected data to one or more of a base station, access point and mobile device via the active RFID chip, and/or via an authenticated wireless transmission via the mobile wireless communication means;
(4) a base station computer application program product operable to run on the base station computer processing means, alone or in conjunction with a conventional operating system, comprising:
(a) computer application program code operable to enable reception of the action initiation command and the sensed/detected data directly from the mobile devices and/or from one or more access points associated with one or more of the mobile devices, and transmit same to the base station computer processing means;
(b) computer application program code operable to enable the base station computer processing means to determine an identity of one or more of the mobile devices via identification of the active RFID chip, the service-subscriber key of the SIM therein, and the MIN, and physical (geographical) location of one or more of the mobile devices;
(c) computer application program code operable to determine an identity of units associated with a mobile device, based on the identified active RFID tag, service-subscriber key of the SIM, MIN or other identification means of the identified mobile device, user of the mobile and/or the determined physical (geographical) location of the mobile device;
(d) computer application program code operable to query a cache of action initiation data, stored on the base station computer storage means or accessible by the base computer processing means, corresponding to the associated units determined in (c) above, to determine one or more appropriate action initiation commands associated with the determined associated units;
(e) computer application program code operable to enable the base station computer processing means to communicate, via the base station wireless communication means or other means, the action initiation commands to the associated units; and
(f) computer application program code operable to transmit data to a user interface means to enable observation of system conditions, and select active controls (action initiation commands) for specific mobile devices and/or the associated units.

2. The wireless network-based action-oriented system of claim 1, wherein the mobile device further comprises a GPS device in communication with the mobile wireless communication means.

3. The wireless network-based action-oriented system of claim 1, wherein the mobile device further comprises a trigger device to initiate communications with the mobile device based on the sensed/detected physical and/or biological parameters.

4. The wireless network-based action-oriented system of claim 1, further comprising one or more stationary and/or mobile system access points in wireless communication with one or more of the mobile devices and one or more of the stationary and/or mobile base stations, the access points operable to extend the communications range of the mobile devices with the base stations.

5. The wireless network-based action-oriented system of claim 1, wherein the mobile device further comprises a graphical user interface in communication with the mobile computer processing means, the graphical user interface operable to display to the user one or more authorized action initiation commands.

6. The wireless network-based action-oriented system of claim 1, wherein the mobile device further comprises a biometric identification means in communication with mobile computer processing means.

7. The wireless network-based action-oriented system of claim 1, wherein the sensors/detectors comprise one or more of a pressure sensor, accelerometer, gyroscope, motion detector, infrared (IR) distance sensor, light sensor (light meter), radioactivity detector/sensor, chemical sensor, physiological parameter sensor, biometric sensor, bioagent detectors, altimeter, air speed indicator, air pressure sensor, olfactory sensor, and acoustic detector.

8. The wireless network-based action-oriented system of claim 1, wherein the mobile device further comprises one or more light emitting devices.

9. The wireless network-based action-oriented system of claim 1, wherein the mobile device further comprises a power source in communication with the mobile device computer processing means.

10. The wireless network-based action-oriented system of claim 1, wherein the mobile device further comprises a reactive device housing comprised of a polydiacetylene-containing polymer.

11. The wireless network-based action-oriented system of claim 1, wherein the base station computer application program product further comprises:
computer application program code operable to associate the service-subscriber key and/or mobile identification number (MIN) of each mobile device with a user identification (including one or more of, but not limited to, name, picture, address, title, biometric data, etc.);
computer application program code operable to correlate user identifications with one or more corresponding authorized action initiation commands; and
computer application program code operable to enable transmission of authorized mobile device action initiation commands to corresponding units.

12. The wireless network-based action-oriented system of the claim 11, wherein the base station computer application program product further comprises:
computer application program operable to automatically alter authorized mobile device action initiation commands associated with the service-subscriber key, MIN, or other identification means of each individual mobile device based on the geographical location of mobile devices.

13. The wireless network-based action-oriented system of claim 11, wherein the base station computer application program product further comprises:
computer application program operable to automatically alter authorized mobile device action initiation commands associated with the service-subscriber key of each individual mobile device based on the geographical location of mobile devices.

14. The wireless network-based action-oriented system of claim 1, wherein the base station computer application program product further comprises:
computer application program code operable to automatically transmit preassigned action initiation commands to corresponding units based on the geographical location of a mobile device.

15. The wireless network-based action-oriented system of claim 5, wherein the mobile computer application program product further comprises:
computer application program code operable to receive authorized action initiation commands; and
computer application program code operable to display the authorized action initiation commands on the graphical user interface.

16. The wireless network-based action-oriented system of claim 5, wherein the mobile computer application program product further comprises:
computer application program code operable to receive altered (revised) authorized action initiation commands; and
computer application program code operable to reconfigure the displayed authorized action initiation commands on the graphical user interface, so as to display the altered authorized action initiation commands.

17. The wireless network-based action-oriented system of claim 5, wherein the mobile computer application program product further comprises:
computer application program code operable to display current associated units authorized to receive action initiation commands from the mobile device on the graphical user interface thereof, and functions of said associated units and/or authorized action initiation commands for each of said associated units.

18. The wireless network-based action-oriented system of claim 1, wherein the mobile computer application program product and/or the base station computer application program product further comprise:
computer application program code operable to enable ad hoc networking of the mobile devices and/or base stations with one another, so as to extend the wireless communications range of system components (mobile devices and base stations).

19. The wireless network-based action-oriented system of claim 6, wherein the mobile computer application program product and/or the base station computer application program product further comprise:
computer application program code operable to correlate biometric data of a user received from the biometric identification means with one or more of an active RFID chip, service-subscriber key and mobile identification number (MIN), so as to identify a user of the mobile device; and
computer application program code operable to correlate one or more of an active RFID chip, service-subscriber key and MIN, with one or more action initiation commands authorized for the identified user of the mobile device.

20. The wireless network-based action-oriented system of claim 1, wherein the associated units comprise:
(a) a unit computer processing means;
(b) a unit station wireless communication means which is in communication with the unit computer processing means, said unit wireless communication means operable to enable wireless communication of the unit computer processing means with one or more stationary and/or mobile base stations, access points and/or one or more mobile devices; and
(c) a unit computer application program product operable to run on the unit computer processing means, alone or in conjunction with a conventional operating system, comprising:
(1) computer application program code operable to enable reception of the action initiation command from one or more of the base stations, one or more access points and one or more mobile devices;
(2) computer application program code operable to determine status of the unit at the time of receipt of the action initiation command;
(3) computer application program code operable to enable the unit computer processing means to transmit an execution order of the action initiation command, based on the determined status of the unit at the time of receipt of the action initiation command, to the unit; and
(4) computer application program code operable to enable the unit computer processing means to communicate the status of the unit after execution of the action initiation command to one or more of the base stations directly or via one or more access points and/or mobile units.

21. The wireless network-based action-oriented system of claim 1, wherein the wireless network is one or more of an interne protocol-based wireless network and a wireless mobile telecommunication network.

22. The wireless network-based action-oriented system of claim 1, wherein two or more of the mobile devices, access points and base stations are operable to form an ad-hoc wireless network.
